(19) United States
(12) Patent Application Publication
(10) Pub. No.: US 2006/0276187 A1
(43) Pub. Date: Dec. 7, 2006

(54) Communication terminal apparatus

(75) Inventor: Koji Suzuki, Kanagawa (JP)

Correspondence Address: STEVENS, DAVIS, MILLER & MOSHER, LLP, 1615 L. STREET N.W., SUITE 850, WASHINGTON, DC, 20036, US

(73) Assignee: MATSUSHITA ELECTRIC INDUSTRIAL CO., LTD., Osaka (JP)

(21) Appl. No.: 11/437,827

(22) Filed: May 22, 2006

(30) Foreign Application Priority Data
May 25, 2005 (JP) 2005-152341

(51) Int. Cl. H04Q 7/20

(52) U.S. Cl. 455/421

(57) ABSTRACT

A communication terminal apparatus that restricts the transmission of electric waves in a call-restricted area without adding redundant circuitry. Mobile telephone 100 identifies base stations 200 and 300 based on scrambling codes defined respectively for base stations 200 and 300 in advance. These scrambling codes are used as identification information for transmission function control. Control base station 300 transmits a specific scrambling code that is not used by general base station 200. Upon receiving from control base station 300, provided in public facilities to control the transmission function of mobile telephone 100, a signal that is coded with the scrambling code assigned to control base station 300, transmission control section 104 stops the function of transmission section 103 and performs control restricting the call function of mobile telephone 100.

### BACKGROUND OF THE INVENTION

1. Field of the Invention

The present invention relates to a communication terminal apparatus such as a mobile telephone.

2. Description of the Related Art

Communication terminal apparatus such as mobile telephones have become widespread, and places where mobile telephones can be used have been expanding. However, the expansion of places where mobile telephones can be used have produced several problems. For example, when mobile telephones are used while driving cars, the probability of causing traffic accidents increases due to careless driving. In addition, when mobile telephones are used in medical facilities or on aircraft, the probability of causing malfunction of electronic devices due to electrical waves generated from the mobile telephones is pointed out. Also, when mobile telephones are used in public places such as movie theaters or trains, there is a problem that the ringing sound and talking voice cause annoyance to people around. In order to solve these problems, the use of mobile telephones is discouraged in such public places and users are advised to voluntarily turn off their mobile telephones.

As a technology for these problems, there is a radio communication apparatus whereby a sub-communication section is provided in a mobile telephone and receives the signal for restricting the use of the mobile telephones (for example, see Japanese Patent Application Laid-Open No. Hei.10-200958).

However, in conventional radio communication apparatus of this kind, redundant circuitry such as sub-communication section is added so as to identify a call-restricted area, which results in a problem of increased complexity in apparatus configuration and higher cost.

### SUMMARY OF THE INVENTION

It is therefore an object of the present invention to provide a communication terminal apparatus whereby the transmission of electric waves can be restricted in a call-restricted area without adding redundant circuitry.

According to an aspect of the invention, the communication terminal apparatus of the present invention employs a configuration having: a reception section that receives a scrambling code defined in advance for each base station; an identifying section that identifies a control base station provided in a call-restricted area from the received scrambling code; and a control section that performs transmission restriction control based on an identification of the control base station.

### BRIEF DESCRIPTION OF THE DRAWINGS

The above and other objects and features of the invention will appear more fully hereinafter from a consideration of the following description taken in connection with the accompanying drawings, in which:

FIG. 1 is a block diagram showing the configuration of the mobile telephone of the communication terminal apparatus and the control base station for call restriction, according to embodiment 1 of the present invention;

FIG. 2 is a flow chart for reception of a call-restricting scrambling code by the communication terminal apparatus, according to above embodiment 1;

FIG. 3 is a block diagram showing the configuration of the mobile telephone of the communication terminal apparatus and the control base station for call restriction, according to embodiment 2 of the present invention;

FIG. 4 is a flow chart for the operation of the communication terminal apparatus entering a call-restricted area, according to above embodiment 2; and

FIG. 5 is a flow chart for the operation of communication terminal apparatus leaving a call-restricted area, according to above embodiment 2.

### DESCRIPTION OF THE PREFERRED EMBODIMENT

Embodiments of the present invention will be explained below in detail with reference to the accompanying drawings.

### EMBODIMENT 1

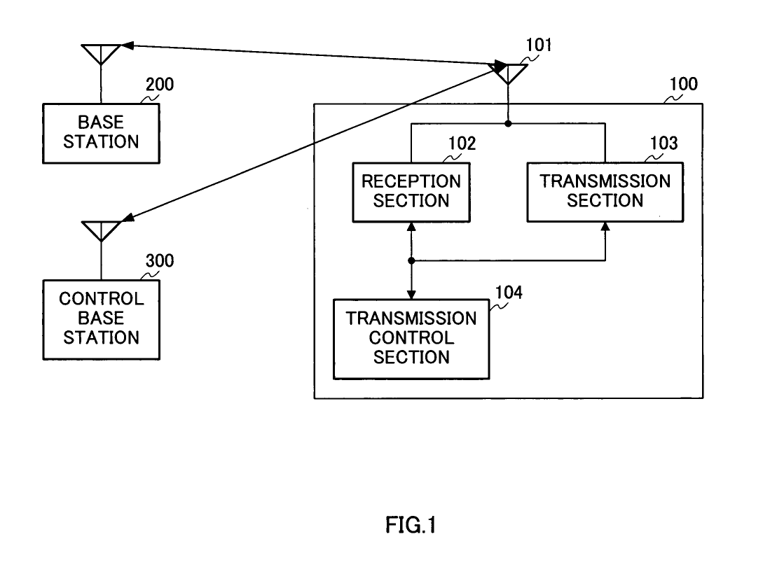

FIG. 1 is a block diagram showing the configuration of the communication terminal apparatus according to embodiment 1 of the present invention. The present embodiment is an example where the communication terminal apparatus is applied to a mobile telephone.

In FIG. 1, mobile telephone 100 performs radio communication by a CDMA (Code Division Multiple Access) communication scheme, between base station 200 of mobile telephone 100, and control base station 300 for designating a call-restricted area.

Mobile telephone 100 is configured having antenna 101, reception section 102, transmission section 103 and transmission control section 104.

Reception section 102 receives a signal from base station 200 and control base station 300, and transmission section 103 transmits a signal to base station 200 and control base station 300. Transmission control section 104 is a control section for call restriction, decides whether or not mobile telephone 100 is in a call-restricted area based on the signal received from reception section 102, and, when mobile telephone 100 is in a call-restricted area, outputs a call restriction signal.

Base station 200 is a general base station for mobile telephone 100 and communicates with other mobile telephones via base station 200.

Control base station 300 is a base station for designating a call-restricted area and is provided in places where the use of mobile telephone 100 is not preferable, including, for example, public facilities such as medical facilities, movie theaters and libraries.

In CDMA communication, mobile telephone 100 identifies base stations 200 and 300 based on scrambling codes defined respectively for base stations 200 and 300 in advance. The present embodiment uses these scrambling codes as identification information for call function control. Control base station 300 transmits a specific scrambling code that is not used by general base station 200. Mobile telephone 100 is capable of receiving both the scrambling code from base station 200 and the specific scrambling code from control base station 300. Control base station 300 is provided in limited call-restricted areas such as public facilities, and, accordingly, electric waves transmitted from control base station 300 are limited. It is only necessary for mobile telephone 100 to receive signals within the call-restricted area, an area of a radius of several meters, and therefore, weak electric filed strength suffices for electric waves transmitted from control base station 300.

The operation of the communication terminal apparatus configured as described above will be explained below. First, the overall operation will be explained.

When mobile telephone 100 enters the coverage range of electric waves transmitted from base station 200, mobile telephone 100, following the conventional manner, automatically receives and transmits electric waves from and to base station 200, so as to register the location of mobile telephone 100. When mobile telephone 100 receives a signal from control base station 300, transmission control section 104 performs control for call restriction and restricts the operation of transmission section 103.

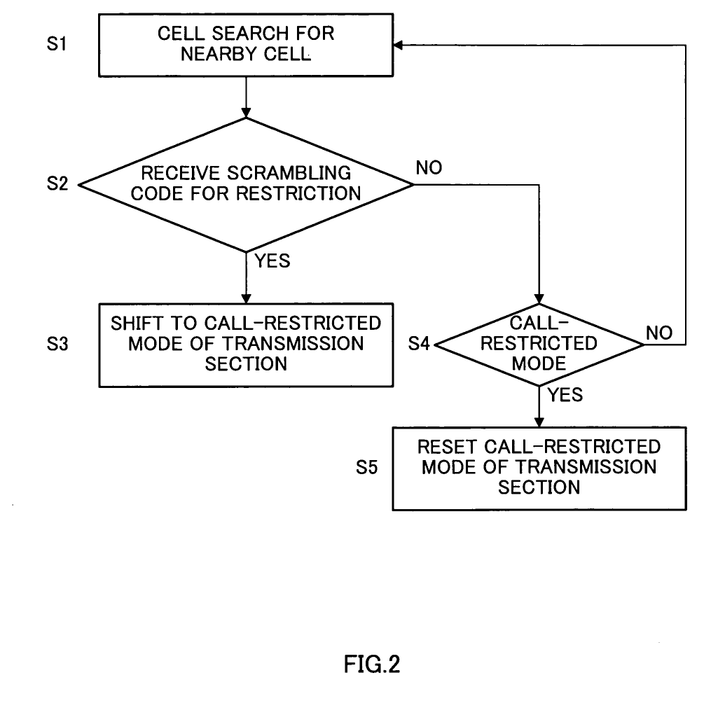

FIG. 2 is a flow chart for the reception of a call-restricting scrambling code by mobile telephone 100. To be more specific, FIG. 2 is a flow chart showing the operation procedure for executing call restriction over mobile telephone 100 when mobile telephone 100 enters a call-restricted area. In this figure, S stands for “step” in the flow.

Mobile telephone 100 in idle mode communicates with nearby base station 200 in the state of step S1. Here, when mobile telephone 100 enters a call-restricted area and receives a signal that is coded with a certain specific scrambling code from control base station 300 (“Yes” in step S2), reception section 102 detects the scrambling code for restriction, and the reception of the scrambling code for restriction is reported to transmission control section 104. When the scrambling code for restriction is detected, transmission control section 104 determines that the area is a call-restricted area and controls mobile telephone 100 to shift into call-restricted mode. In addition, a call restriction signal is transmitted to transmission section 103 to stop the function of transmission section 103 (step S3).

On the other hand, when mobile telephone 100 leaves the range of the call-restricted area and a signal coded with the scrambling code for restriction can no longer be identified (“No” in step S2), whether or not mobile telephone 100 is in call-restricted mode is determined. When mobile telephone 100 is in call-restricted mode (“Yes” in step S4), transmission control section 104 resets the call restriction and restarts the function of transmission section 103 (step S5).

At this time, it is also possible to inform the user of the place where the use of mobile telephones is prohibited, by vibration or by alarm, so as to restrict the function of mobile telephone 100.

The call-restricted area refers to areas where electric waves of control base station 300 can be received, including the inside of cars, theatres, movies theaters and so on.

As described above, according to embodiment 1, upon receiving from control base station 300, provided in public facilities to control the transmission function of mobile telephone 100, a signal that is coded with a scrambling code assigned to control base station 300, transmission control section 104 stops the function of transmission section 103 and performs control restricting the transmission function of mobile telephone 100, so that the call function of mobile telephone 100 can be restricted in places where the use of mobile telephone 100 is not preferable, without adding redundant circuitry.

In addition, since the present embodiment uses a signal that is coded with an existing scramble code, there is no need to add new circuitry and increase the circuit scale In addition, the present embodiment provides an advantage of requiring minimum element changes, which makes the embodiment readily implementable, at low cost.

### EMBODIMENT 2

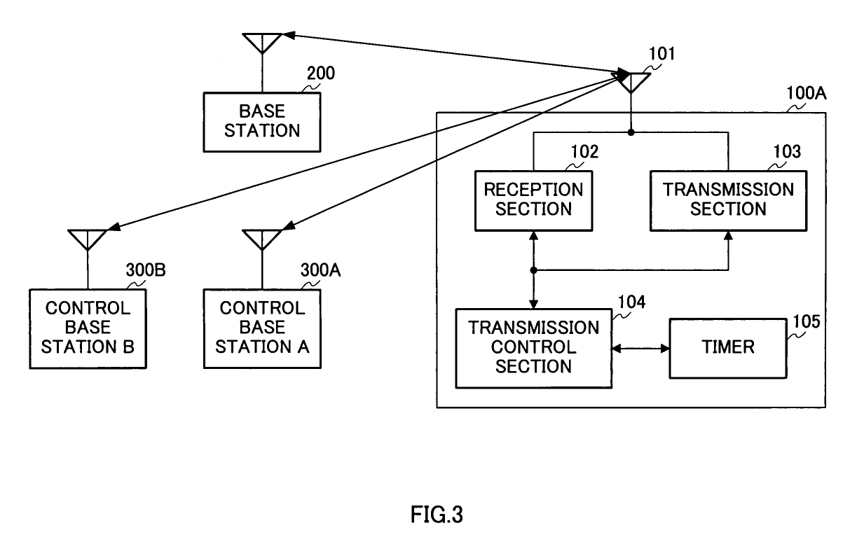

FIG. 3 is a block diagram showing the configuration of the communication terminal apparatus according to embodiment 2 of the present invention. In the following description of the present embodiment, elements that are the same as in FIG. 1 will be assigned the same reference numerals.

In FIG. 3, mobile telephone 100A is provided with timer 105. Mobile telephone 100A performs radio communication with base station 200 of mobile telephone 100A, and control base stations 300A and 300B for designating a call-restricted area. Control base station 300A is a control base station for identifying mobile telephone 100A leaving a gate to a call-restricted area, and control base station 300B is a control base station that outputs a scrambling code different from control base station 300A.

The operation of the communication terminal apparatus configured as described above will be explained below.

Assume that control base station 300A is provided outside the call-restricted area and control base station 300B is provided inside the call-restricted area.

First, the operation of mobile telephone 100A entering the call-restricted area through a call restriction gate, will be explained. The call-restricted area gate may be an entrance/exit of a hospital or a theater and a ticket gate of a station.

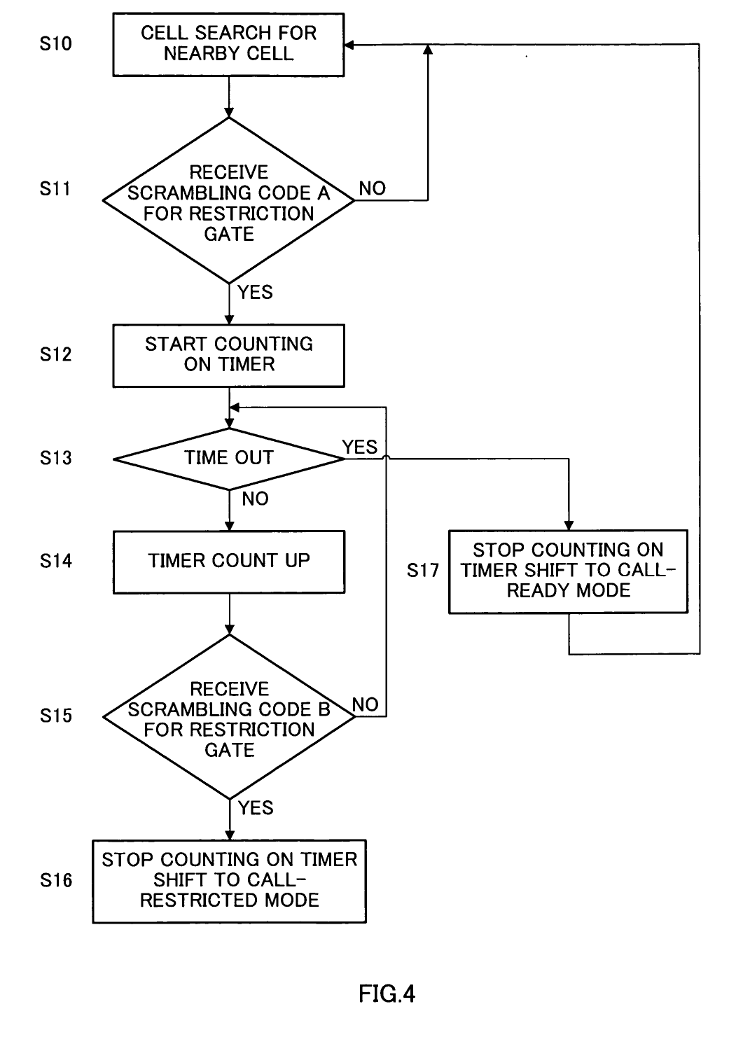

FIG. 4 is a flow chart showing the operation procedure of mobile telephone 100A entering a call-restricted area when control base stations 300A and 300B are used as gates to the call-restricted area.

In FIG. 4, mobile telephone 100A in idle mode communicates with nearby base station 200 in the state of step S10. Here, when mobile telephone 100A enters the call-restricted area and receives a signal that is coded with a certain specific scrambling code A from control base station 300A (“Yes” in step S11), detects scrambling code A for restriction gate in reception section 102 and reports the reception of scrambling code A for restriction gate to transmission control section 104. Upon receiving a report that scrambling code A for restriction gate is detected, transmission control section 104 determines that mobile terminal 100A is entering a call-restricted area, and starts counting on timer 105 (step S12). Before timer 105 counts a predetermined time and time is out (“No” in step S13 and step S14), when scrambling code B for restriction gate transmitted from control base station 300B is detected (“Yes” in step S15), transmission control section 104 determines that mobile telephone 100A has entered the call-restricted area and makes mobile telephone 100A shift into call-restricted mode. In addition, transmission control section 104 transmits a call restriction signal to transmission section 103 and stops the function of transmission section 103 (step S16). On the other hand, when time is out in step S13, transmission control section 104 stops counting time in step S17, shifts to call-ready mode, returns to step S10 and continues search for nearby cells.

Next, the operation of mobile telephone 100A leaving a call-restricted area through a call restriction gate will be explained.

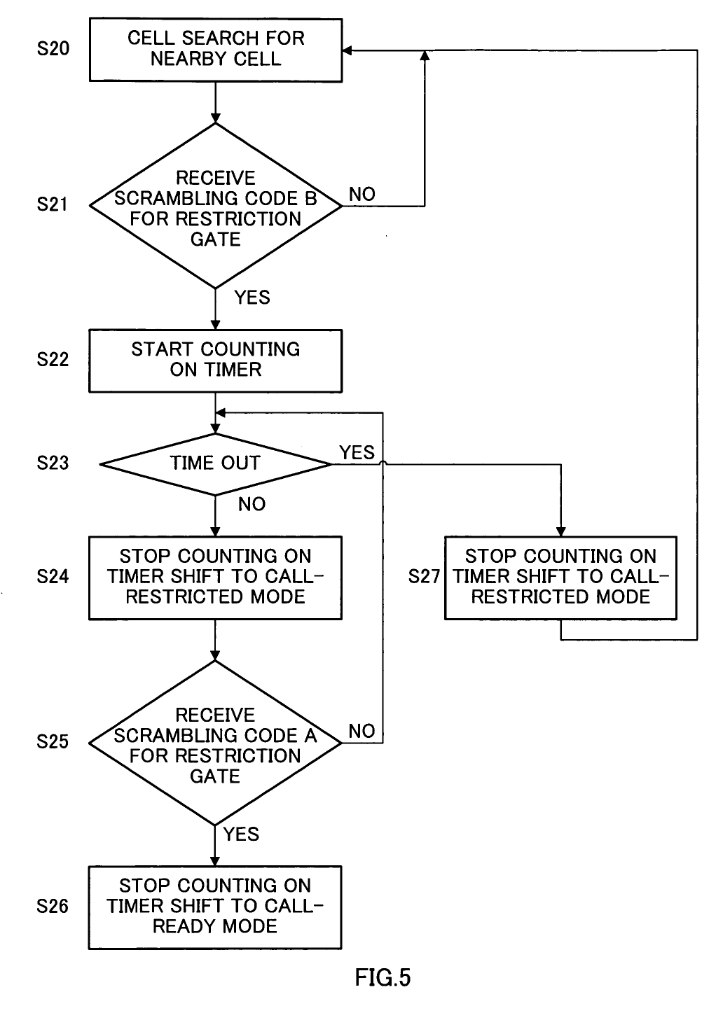

FIG. 5 is a flow chart for the operation procedure of mobile telephone 100A leaving a call-restricted area when control base station B is used as a gate to the call-restricted area.

Mobile telephone 100A having entered the call-restricted area is in call-restricted mode in accordance with the above flow chart of FIG. 4. In FIG. 5, mobile telephone 100A in call-restricted mode receives a signal from base station 200 in the state of step S20. Here, when mobile telephone 100A moves closer to control base station 300B from the call-restricted area and receives a signal that is coded with scrambling code B for restriction gate (“Yes” in step S21), reception section 102 detects scrambling code B for restriction gate, and the reception of scrambling code B for restriction gate is reported to transmission control section 104. Upon receiving a report that scrambling code B for restriction gate is detected, transmission control section 104 determines that mobile telephone 100A is leaving the call-restricted area, and starts counting on timer 105 (step S22) Before timer 105 counts a certain time and time is out (“No” in step S23), transmission control section 104 stops counting time on timer 105, and shifts into call-ready mode (step S24), and, when scrambling code A for restriction gate that is transmitted from control base station 300A is detected (“Yes” in step S25), transmission control section 104 determines that mobile telephone 100A has left the call-restricted area and makes mobile telephone 100A shift into call-ready mode. In addition, transmission control section 104 transmits a signal that resets the call restriction over transmission section 103 and restarts the function of transmission section 103 (step S26). On the other hand, when time is out in step S23, transmission control section 104 stops counting time in step S27, shifts into call-ready mode, returns to step S20 and continues search for nearby cells.

As described above, according to embodiment 2, a number of control base stations 300A and 300B are provided, and entry in and exit from a call-restricted area are determined by the order of scrambling codes received at mobile phone 100A and control is performed restricting the transmission function of mobile telephone 100A, so that the call function of mobile telephone 100A can be restricted more precisely in places where the use of mobile telephone 100A is not preferable.

The above explanation is an example of a preferred embodiment of the present invention, and the scope of the present invention is not limited to this.

Although the above-described embodiments are examples of the communication terminal apparatus applied to a mobile telephone, the present invention is applicable to any communication terminals that perform transmission and reception with a base station. For example, the communication terminal apparatus is applicable to cordless telephones that connect a master phone and a number of slave phones by radio communication, PDAs (Personal Digital Assistants) provided with radio communication functions, and small-sized notebook computers.

In addition, in the above embodiments, any signaling method can be used to signal a stop of the transmission function. For example, it is possible to send signaling by displaying a message on a display section, by turning on a light such as a LED and by using voice or sound. Furthermore, the type, number and connecting method of circuit sections forming the above mobile telephone 100 (for example, control section) are not limited to the above-described embodiments.

The above-described communication terminal apparatus can be realized by a program for operating this communication terminal apparatus. This program may be stored in a recording medium that is readable by computers.

Consequently, by providing a control base station applying the present invention in a hospital, at a ticket gate of a station, at a boarding gate of an airport and so forth, the communication terminal apparatus of the present invention is useful for systems that restrict the call function of communication terminal apparatus. By this means, it is possible to solve problems caused by the widespread use of communication terminal apparatus, preventing, for example, malfunction due to electric waves transmitted from communication terminal apparatus and traffic accidents.

The present invention is not limited to the above described embodiments, and various variations and modifications may be possible without departing from the scope of the present invention.

This application is based on Japanese Patent Application No.2005-152341, filed on May 25, 2005, the entire content of which is expressly incorporated by reference herein.

What is claimed is:

1. A communication terminal apparatus comprising:
a reception section that receives a scrambling code defined in advance for each base station;
an identifying section that identifies a control base station provided in a call-restricted area from the received scrambling code; and
a control section that performs transmission restriction control based on an identification of the control base station.

2. The communication terminal apparatus according to claim 1, wherein the control section performs one of control stopping an operation of a transmission function section and control resetting a stop of the operation.

3. The communication terminal apparatus according to claim 1, wherein the transmission function section further comprises a reporting section that reports one of an active mode and a non-active mode of the transmission function section.
